(19) United States
(12) Patent Application Publication
(10) Pub. No.: US 2023/0296768 A1
(43) Pub. Date: Sep. 21, 2023

(54) BLIND-SPOT WARNING

(71) Applicant: Valeo Schalter und Sensoren GmbH, Bietigheim-Bissingen (DE)

(72) Inventors: Maxime Courtois, Bietigheim-Bissingen (DE); Nicolas Costini, Bietigheim-Bissingen (DE)

(73) Assignee: Valeo Schalter und Sensoren GmbH, Bietigheim-Bissingen (DE)

(21) Appl. No.: 18/019,920

(22) PCT Filed: Aug. 2, 2021
(86) PCT No.: PCT/EP2021/071514

§ 371 Date: Feb. 6, 2023

(30) Foreign Application Priority Data
Aug. 6, 2020 (DE) 10 2020 120 726.3

(51) Int. Cl. G01S 15/931; G01S 15/87

(52) U.S. Cl. CPC G01S 15/931; G01S 15/876; G01S 2013/9315

(57) ABSTRACT

The invention relates to a sensor arrangement (12), in particular for use for a driving assistance system of a vehicle (10), having a plurality of ultrasonic sensors (14) which are arranged along at least a front (20) and/or a rear (22) of the vehicle (10), wherein the ultrasonic sensors (14) are divided into a group (26) of right-hand ultrasonic sensors (14) and a group (24) of left-hand ultrasonic sensors (14), and the sensor arrangement (12) has asymmetric operation in which the ultrasonic sensors (14) in one group (24, 26) of ultrasonic sensors (14) at least partially have a lower receiving sensitivity than corresponding ultrasonic sensors (14) in the other group (26, 24) of ultrasonic sensors (14). The invention also relates to a method for operating such a sensor arrangement (12).

The present invention relates to a sensor arrangement, in particular for use for a driving assistance system of a vehicle, having a plurality of ultrasonic sensors which are arranged along at least a front and/or a rear of the vehicle.

The present invention also relates to a method for operating a sensor arrangement, in particular for use for a driving assistance system of a vehicle, having a plurality of ultrasonic sensors which are arranged along at least a front and/or a rear of the vehicle.

Various types of sensor arrangements on vehicles are known. These sensor arrangements comprise a plurality of ultrasonic sensors which, for example as a parking pilot system, output a distance warning when an obstacle is approached, so that a current parking process can be interrupted and adapted to the detected obstacle. In principle, such sensor arrangements can manage without a superordinate control device if the ultrasonic sensors or one of the ultrasonic sensors generate or generates the distance warning. Alternatively, the sensor arrangement can have a control device which is connected to the ultrasonic sensors via a data connection, for example in the manner of a data bus or with a star topology, and generates the distance warning based on signals received from the ultrasonic sensors.

A blind spot in a vehicle refers to an area to the side of the vehicle that is not directly visible to a driver or within the field of view of a side mirror. The blind spot is specified in vehicle construction according to standards. This standardized blind spot accordingly extends alongside the vehicle in the longitudinal direction from approximately a driver’s position toward the rear of the vehicle, typically to an area approximately 3 meters behind the vehicle. The standardized blind spot also has a width of 2.5 meters to 3 meters next to the vehicle. Even if a partial area of this standardized blind spot is visible in practice, this entire area next to and behind the vehicle is typically counted as part of the blind spot area. A blind spot exists on both a driver’s side and a passenger’s side of the vehicle.

A driver assistance system for blind spot monitoring nowadays comprises one or usually a plurality of environmental sensors which are arranged along a longitudinal side of the vehicle and detect the approach of objects in this area.

During blind spot monitoring, a blind spot warning will be output if an environmental sensor detects an object in the defined blind spot area during the journey. This is especially true when the object is approaching. In this case, the blind spot monitoring is usually carried out independently for a driver’s and a passenger’s side of the vehicle. Ultrasonic sensors, which are reliable and at the same time available at low cost, can be used as environmental sensors. In addition, the ultrasonic sensors can be used jointly for different driving assistance systems, so that separate ultrasonic sensors do not have to be used for each driving assistance system. The above-mentioned parking aids, which use ultrasonic sensors to monitor an environment of the vehicle, in particular on a front and/or rear bumper, i.e. on a front and/or rear end face of the vehicle, may be mentioned here by way of example.

A common problem in blind spot monitoring concerns blind spot warnings output by the system when there is no real danger, so-called false positive detections of objects. Such false positive detections can occur, for example, due to spray, i.e. when the ultrasonic sensors detect water splashing from a surface and this is incorrectly identified as an object in the blind spot. Errors caused by the detection of spray relate in particular to water which is splashed by the vehicle itself and is in the vicinity of the vehicle’s environmental sensors. Spray is mainly thrown up by the vehicle itself, the ego vehicle, but can in principle also be caused by third-party vehicles located next to the ego vehicle, either by vehicles moving in the same direction of travel, i.e. overtaken or overtaking vehicles, or by vehicles moving in an opposite direction of travel.

Another common cause of false positive detections can be road signs or other similar objects, for example. Road signs often have a small depth in a direction parallel to the direction of travel of passing vehicles, so that they can be detected only with difficulty next to the ego vehicle by ultrasonic sensors attached to the side of the latter. Once the vehicle has passed the sign, the sign enters a sensor receiving area of a partially rearward-facing ultrasonic sensor, as a result of which it is detected immediately and results in the output of a blind spot warning. However, such road signs are usually not dangerous objects for which a blind spot warning must be output. Road signs relate to any type of official traffic signs, information signs and also any posts or masts of other installations next to a road that have a corresponding characteristic to the road signs mentioned.

In this context, DE 10 2017 119 042 A1 discloses an improvement in blind spot monitoring with avoidance of blind spot warnings caused by spray. The driver assistance system known therefrom comprises at least one first environmental sensor for monitoring the blind spot, at least one second environmental sensor that monitors a second area on a rear end face of the vehicle, and a control unit that is designed to receive sensor signals from the at least one first environmental sensor and the at least one second environmental sensor, wherein the control unit is designed to carry out object detection in the blind spot based on the sensor signals from the at least one first environmental sensor and object detection in the second area based on the sensor signals from the at least one second environmental sensor, the control unit is designed to determine a probability of spray being detected based on the object detection in the blind spot and in the second area, and the control unit is designed to output a blind spot warning when an approaching object is detected in the blind spot when the probability of detecting spray is below a limit value.

Proceeding from the prior art mentioned above, the invention is therefore based on the object of specifying a sensor arrangement having a plurality of ultrasonic sensors and a method for operating such a sensor arrangement, which enable improved detection of obstacles, in particular in order to prevent incorrect detection of obstacles when outputting blind spot warnings.

The object is achieved according to the invention by the features of the independent claims. Advantageous configurations of the invention are specified in the dependent claims.

The invention therefore specifies a sensor arrangement, in particular for use for a driving assistance system of a vehicle, having a plurality of ultrasonic sensors which are arranged along at least a front and/or a rear of the vehicle, wherein the ultrasonic sensors are divided into a group of right-hand ultrasonic sensors and a group of left-hand ultrasonic sensors, and the sensor arrangement has asymmetric operation in which the ultrasonic sensors in one group of ultrasonic sensors at least partially have a lower receiving sensitivity than corresponding ultrasonic sensors in the other group of ultrasonic sensors.

The invention also specifies a method for operating a sensor arrangement, in particular for use for a driving assistance system of a vehicle, having a plurality of ultrasonic sensors which are arranged along at least a front and/or a rear of the vehicle, wherein the ultrasonic sensors are divided into a group of right-hand ultrasonic sensors and a group of left-hand ultrasonic sensors, comprising the steps of capturing switch actuation and/or at least one parameter from a travel speed, a change in the direction of travel, a lane being used by the vehicle from a plurality of available directional lanes, a traffic mode with right-hand traffic or left-hand traffic and at least one environmental condition, and changing over a receiving sensitivity of at least one of the groups of ultrasonic sensors between normal operation, in which corresponding ultrasonic sensors in both groups have a substantially identical receiving sensitivity, and asymmetric operation, in which the ultrasonic sensors in one group of ultrasonic sensors at least partially have a lower receiving sensitivity than corresponding ultrasonic sensors in the other group of ultrasonic sensors on the basis of the switch actuation and/or the at least one parameter.

The basic idea of the present invention is therefore to reduce false positive detections of objects by virtue of the ultrasonic sensors of the vehicle, depending on their arrangement on a right-hand or left-hand side of the vehicle, carrying out asymmetric operation in which the ultrasonic sensors on one of the two sides of the vehicle at least partially have a lower receiving sensitivity than the corresponding ultrasonic sensors on the other side of the vehicle. In this way, during asymmetric operation, it can be taken into account that false positive detections of objects by the ultrasonic sensors on one side of the vehicle increasingly occur, depending on various factors. As a result, it can be taken into account, for example, that road signs are usually located at the edge of a road, usually at the right-hand edge in the case of right-hand traffic and vice versa in the case of left-hand traffic. Accordingly, such road signs only on a right-hand side of the vehicle can therefore lead to false detections of objects. Road signs include any type of official traffic signs, information signs and also any posts or masts of other installations next to a road that have a corresponding or comparable characteristic for ultrasonic sensors to the road signs mentioned. The occurrence of spray is also usually different for both sides of the vehicle based on a normal road profile. Thus, rain usually has to run off over the road to an edge of the road, as a result of which the spray can occur to a greater extent at the edges of the road and can accordingly lead to false detections of objects there. In the case of right-hand traffic, this usually affects the right-hand edge of the road and thus of the vehicle, and accordingly vice versa in the case of left-hand traffic.

The plurality of ultrasonic sensors usually include ultrasonic sensors arranged along at least a front and/or a rear of the vehicle. In addition, ultrasonic sensors can also be arranged in side areas of the vehicle. In the present case, asymmetric operation relates in particular to those ultrasonic sensors which are used by a corresponding driving assistance system. In a driving assistance system for blind spot monitoring, these may be, for example, a front, laterally oriented ultrasonic sensor, a rear, laterally oriented ultrasonic sensor and a rear, rearwardly oriented ultrasonic sensor on each side of the vehicle.

In principle, each of the groups of right-hand and left-hand ultrasonic sensors can only have one ultrasonic sensor. However, the vehicle usually has a higher number of ultrasonic sensors, so that each of the groups of ultrasonic sensors has a plurality of ultrasonic sensors.

The ultrasonic sensors are divided into the two groups, for example, along a central axis of the vehicle based on a longitudinal direction of the vehicle. Here, the group of left-hand ultrasonic sensors is formed by all the ultrasonic sensors positioned to the left of the central axis of the vehicle, and the group of right-hand ultrasonic sensors is formed by all the ultrasonic sensors positioned to the right of the central axis of the vehicle. In left-hand-drive vehicles, the left-hand side of the vehicle corresponds to the driver’s side, while the right-hand side corresponds to the passenger’s side. The opposite applies to right-hand-drive vehicles. Ultrasonic sensors on the central axis can be arbitrarily assigned to one of the two groups or alternatively disregarded.

Corresponding ultrasonic sensors are ultrasonic sensors that are positioned on the vehicle in a comparable manner in the two groups. The ultrasonic sensors in both groups are usually attached at the same positions based on a longitudinal axis of the vehicle, as a result of which pairs of corresponding ultrasonic sensors are formed in each case. In particular in the area of the front and/or rear, a plurality of ultrasonic sensors in each group can be positioned at substantially the same positions based on a longitudinal axis of the vehicle. Corresponding ultrasonic sensors can therefore also be distinguished based on their distance from the central axis of the vehicle and/or their orientation.

The sensor arrangement can comprise any number of ultrasonic sensors. In principle, the ultrasonic sensors can manage without a superordinate control device if, for example, the ultrasonic sensors or one of the ultrasonic sensors generate or generates a distance warning. For this purpose, for example, ultrasonic sensors on a front and/or a rear of the vehicle are each connected to one another via a data connection, usually in the manner of a data bus. In that case, the ultrasonic sensors in the two groups can be permanently configured for asymmetric operation, for example. A simple changeover between normal operation and asymmetric operation can also be implemented in this way, for example via a signal line to which different signal levels can be applied for changing over between normal operation and asymmetric operation.

Alternatively, the sensor arrangement can comprise a control device which is connected to the ultrasonic sensors via a data connection, for example in the manner of a data bus or with a star topology. The control device can configure and/or monitor the ultrasonic sensors. In addition, the control device can receive sensor signals from the connected ultrasonic sensors and, for example, generate the distance warning based thereon.

The driving assistance system is in particular a driving assistance system for blind spot monitoring. A corresponding blind spot warning is output by the driving assistance system if one of the ultrasonic sensors, which at least partially covers the blind spot, detects an object in the area of a defined blind spot during the journey with the vehicle. This is especially true when the object is approaching. In this case, the blind spot monitoring is usually carried out independently for a driver’s and a passenger’s side of the vehicle.

The blind spot linguistically refers to an area to the side of the vehicle that is not directly visible to a vehicle driver or within the field of view of a side mirror of the vehicle. The blind spot is specified in vehicle construction according to standards. This standardized blind spot accordingly extends alongside the vehicle in the longitudinal direction from approximately a driver’s position toward the rear of the vehicle, typically to an area approximately 3 meters behind the vehicle. The standardized blind spot also has a width of 2.5 meters to 3 meters next to the vehicle. Even if a partial area of this standardized blind spot is visible in practice, this entire area next to and behind the vehicle is typically counted as part of the blind spot area. The blind spot exists on both a driver’s side and a passenger’s side of the vehicle.

The lower receiving sensitivity of the ultrasonic sensors can be adjusted, for example, by increasing a signal threshold, that is to say a signal level, of a sensor signal from the ultrasonic sensor, wherein a warning is output based on a sensor signal from the respective ultrasonic sensor if the signal threshold is exceeded. Alternatively or additionally, the lower receiving sensitivity can be achieved by increasing a period of time over which a sensor signal must detect an object in order to output a warning.

Depending on a configuration of the sensor arrangement, the receiving sensitivity is configured or changed directly on the respective ultrasonic sensor, in particular via the control device, if the sensor arrangement has a control device. Alternatively, in a sensor arrangement having a control device, the receiving sensitivity for a respective ultrasonic sensor can be adjusted in the control device itself by processing sensor signals transmitted from the ultrasonic sensor to the control device in different ways. In this case, sensor raw data from the ultrasonic sensors, for example, can be transmitted as sensor signals via the data connection or sensor data preprocessed in any manner based on the sensor raw data. Sensor data preprocessed based on the sensor raw data can be distance signals generated therefrom, for example.

The data connection between the control device and the ultrasonic sensors is implemented, for example, as a serial data bus or in the manner of a star connection, in which each of the ultrasonic sensors is connected directly to the control device. The data connection can be implemented, for example, using a CAN bus known per se or other data buses used in the automotive sector.

In an advantageous configuration of the invention, asymmetric operation has operation with a reduced sensitivity on the right-hand side and/or operation with a reduced sensitivity on the left-hand side, wherein, during operation with a reduced sensitivity on the right-hand side, the ultrasonic sensors in the group right-hand ultrasonic sensors at least partially have a lower receiving sensitivity than corresponding ultrasonic sensors in the group of left-hand ultrasonic sensors, and, during operation with a reduced sensitivity on the left-hand side, the ultrasonic sensors in the group of left-hand ultrasonic sensors at least partially have a lower receiving sensitivity than corresponding ultrasonic sensors in the group of right-hand ultrasonic sensors. The vehicle or the sensor arrangement can thus be optimized in such a way that the ultrasonic sensors on a desired side of the vehicle have a lower sensitivity. As a result, the asymmetric design of the sensor arrangement can be configured or adapted, for example, for a traffic mode with right-hand traffic or left-hand traffic. A vehicle can be configured to operate asymmetrically depending on whether the vehicle is a right-hand-drive or left-hand-drive vehicle.

In an advantageous configuration of the invention, the group of ultrasonic sensors which, during asymmetric operation, at least partially have a lower receiving sensitivity than corresponding ultrasonic sensors in the other group of ultrasonic sensors has at least one subgroup of front ultrasonic sensors and one subgroup of rear ultrasonic sensors, wherein, during asymmetric operation, at least the subgroup of rear ultrasonic sensors at least partially has a lower receiving sensitivity than corresponding ultrasonic sensors in the other group of ultrasonic sensors. There is thus asymmetric operation for the ultrasonic sensors of the sensor arrangement depending on their sensor position based on a longitudinal direction of the vehicle. As a result, it can be taken into account for the occurrence of spray, for example, that spray occurs substantially behind the vehicle based on a direction of travel, as a result of which the incorrect detection of objects caused by spray increasingly affects ultrasonic sensors attached to the rear of the vehicle, i.e. ultrasonic sensors in the area of the subgroup of rear ultrasonic sensors. Accordingly, asymmetric operation is particularly relevant for these ultrasonic sensors, while for example the subgroup of front ultrasonic sensors can have the same input sensitivity as the corresponding ultrasonic sensors in the other sensor group. Also, the erroneous detection of road signs occurs predominantly for the ultrasonic sensors attached to the rear of the vehicle, i.e. in the area of the subgroup of rear ultrasonic sensors, which is why a distinction between the subgroups of front and rear ultrasonic sensors is also useful for this reason. In principle, a distinction can also be made between further subgroups. In principle, it is sufficient for the subgroups to each have one ultrasonic sensor. Usually, however, the subgroups each have a plurality of ultrasonic sensors.

In an advantageous configuration of the invention, the ultrasonic sensors in the group of ultrasonic sensors which, during asymmetric operation, at least partially have a lower receiving sensitivity than corresponding ultrasonic sensors in the other group of ultrasonic sensors at least partially have a different degree of lower receiving sensitivity than corresponding ultrasonic sensors in the other group of ultrasonic sensors, depending on their position on the vehicle. For asymmetric operation, the receiving sensitivity of the ultrasonic sensors of the sensor arrangement is therefore adjusted depending on their sensor position based on a longitudinal direction of the vehicle. As a result, it can be taken into account for the occurrence of spray, for example, that spray occurs substantially behind the vehicle in the direction of travel, as a result of which the incorrect detection of objects caused by spray increasingly affects ultrasonic sensors attached to the rear of the vehicle. Accordingly, for example, the receiving sensitivity of the ultrasonic sensors can be reduced to a greater extent for ultrasonic sensors positioned at the rear of the vehicle than for ultrasonic sensors positioned at the center of the vehicle. The receiving sensitivity of the ultrasonic sensors positioned at the center of the vehicle can in turn be reduced to a greater extent than for ultrasonic sensors positioned at the front of the vehicle. The adjustment of the ultrasonic sensors can be carried out individually in each case or for groups of ultrasonic sensors. The erroneous detection of road signs also occurs predominantly for ultrasonic sensors attached to the rear of the vehicle, which is why different adjustment of the receiving sensitivity of the ultrasonic sensors depending on their position on the vehicle is also useful for this reason.

In an advantageous configuration of the invention, the sensor arrangement has a control device which is connected to the plurality of ultrasonic sensors via a data connection, wherein the sensor arrangement is designed to change over the receiving sensitivity of at least one of the groups of ultrasonic sensors between normal operation, in which corresponding ultrasonic sensors in both groups have a substantially identical receiving sensitivity, and asymmetric operation, and/or to adapt asymmetric operation. The setting of asymmetric operation is therefore not firmly specified, but rather can be activated and/or changed by the control device. This means that the activated asymmetric operation can be deactivated again by the control device. The control device can be prompted by a setting or configuration for the sensor arrangement via a user interface of the vehicle to activate and/or adapt asymmetric operation. Asymmetric operation can thus be started and/or adapted by a vehicle driver, for example in order to adapt asymmetric operation for a traffic mode with right-hand or left-hand traffic or to start asymmetric operation when driving onto a freeway. Alternatively, the control device can be designed to automatically change over and/or adapt asymmetric operation, as described in detail below. Various parameters can be taken into account for the automatic changing over and/or adaptation of asymmetric operation, as will become apparent from the explanations below.

In an advantageous configuration of the invention, the control device is designed to change over between normal operation and asymmetric operation and/or to adapt asymmetric operation, also taking into account a travel speed of the vehicle. This makes it possible, for example, to effectively adapt to the occurrence of spray which usually occurs only from a travel speed of more than 40 to 50 km/h and can thus lead to an impairment of the function of the ultrasonic sensors. For example, asymmetric operation can be started from a limit speed of 40 to 50 km/h. In addition, if the occurrence of spray increases further at travel speeds higher than the limit speed, it is also possible to consider further reducing the sensitivity of the ultrasonic sensors in the group of ultrasonic sensors which at least partially have a lower receiving sensitivity than corresponding ultrasonic sensors in the other group of ultrasonic sensors, or adjusting it in another way. The control device may be designed to receive a signal indicating the travel speed of the vehicle, for example based on odometry information relating to the vehicle or based on satellite navigation signals. Alternatively, the control device can be designed to determine the travel speed of the vehicle itself based on the information provided. Detection that the vehicle is currently on a freeway, for example based on satellite navigation signals and associated map information, can indicate that the vehicle is - at least usually - moving at a travel speed above the limit speed, with the result that, for example, based on this, asymmetric operation can be activated or deactivated.

In an advantageous configuration of the invention, the control device is designed to change over between normal operation and asymmetric operation and/or to adapt asymmetric operation, also taking into account a change in the direction of travel of the vehicle. The change in the direction of travel relates in particular to a change in the direction of travel toward that side of the vehicle on which the ultrasonic sensors in the group of ultrasonic sensors which, during asymmetric operation, at least partially have a lower receiving sensitivity than corresponding ultrasonic sensors in the other group of ultrasonic sensors are located. Thus, when the direction of travel is changed, it can be ensured that the environment of the vehicle can be monitored with the best possible accuracy in this area which is particularly critical during the change in the direction of travel. In this case, for example, a higher occurrence of false positive detections of objects can be temporarily tolerated. The change in the direction of travel can include turning, cornering or a lane change. The change in the direction of travel can be currently being carried out or can be currently imminent. The control device is preferably designed to receive a signal indicating the change in the direction of travel of the vehicle, for example a signal relating to turn signal actuation or a steering lock of the vehicle, which are performed either by the vehicle driver or an autonomous driving function. The signal can be additionally or alternatively generated by a navigation system if a change in the direction of travel is required based on a planned trajectory and a current vehicle position.

In an advantageous configuration of the invention, the control device is designed to change over between normal operation and asymmetric operation and/or to adapt asymmetric operation, also taking into account a lane being used by the vehicle from a plurality of available directional lanes. As a result, for example, it can be taken into account that road signs are usually located at the edge of a road, but not between individual lanes. In the case of multi-lane roads, such signs can therefore appear only on the right-hand side of the vehicle when using a right-hand lane and on the left-hand side of the vehicle when using a left-hand lane, and can lead to incorrect detections of objects. When a plurality of directional lanes are available, the occurrence of spray often also depends on the lane being used. Thus, rain usually has to run off over the road to an edge of the road, as a result of which the spray can occur to a greater extent at the edges of the road and can accordingly lead to false detections of objects. Accordingly, for example when driving in a middle or left-hand lane, asymmetric operation can be deactivated, or asymmetric operation is carried out with a changed receiving sensitivity. Adapting asymmetric operation also makes it possible to take into account that, particularly when a plurality of directional lanes are available, additional spray can be generated by other vehicles and can lead to the incorrect detection of objects.

In an advantageous configuration of the invention, the control device is designed to change over asymmetric operation between operation with a reduced sensitivity on the right-hand side and operation with a reduced sensitivity on the left-hand side, depending on a lane being used by the vehicle from a plurality of available directional lanes. Accordingly, for example when driving in a right-hand lane, asymmetric operation can be carried out with a reduced sensitivity on the right-hand side, while, when driving in a left-hand lane, asymmetric operation is carried out with a reduced sensitivity on the left-hand side. This makes it possible to take into account the occurrence of interfering influences caused by spray and/or road signs depending on the lane being used and to reduce their influence.

The lane being used from from a plurality of available directional lanes can be determined based on capture of an environment of the vehicle with a camera and/or another environmental sensor. Alternatively or additionally, based on data from a global navigation satellite system (GNSS) together with corresponding map information, it is possible to detect whether a plurality of directional lanes are available and/or which of the directional lanes is being used by the vehicle.

In an advantageous configuration of the invention, the control device is designed to change over asymmetric operation between operation with a reduced sensitivity on the right-hand side and operation with a reduced sensitivity on the left-hand side, depending on a traffic mode with right-hand traffic or left-hand traffic. The vehicle can therefore also be changed over when changing from a region with a traffic mode with right-hand traffic or left-hand traffic to a region with a different traffic mode in each case in order to ensure optimal use of the sensor arrangement. The traffic mode may be determined, for example, based on data from a global navigation satellite system (GNSS). Alternatively, a setting can be made via a user interface of the vehicle and is implemented via the control device.

In an advantageous configuration of the invention, the control device is designed to change over between normal operation and asymmetric operation and/or to adapt asymmetric operation, also taking into account at least one environmental condition. The at least one environmental condition is an environmental condition that is relevant to the operation of the ultrasonic sensors. This applies in particular to moisture in the form of precipitation and in particular spray caused by it. In particular, the occurrence of spray may be estimated based on current precipitation, previous precipitation, ground moisture, the occurrence of aquaplaning, and/or the activation of windshield wipers of the vehicle, for example. The at least one environmental condition can be captured based on a sensor system of the vehicle. Alternatively or additionally, the at least one environmental condition can be determined based on a received weather forecast or current weather information. The activation of windshield wipers of the vehicle can be detected from actuation of a corresponding switch of the vehicle or in the case of automatic windshield wiper activation, for example based on a control signal.

In an advantageous configuration of the invention, the control device is designed to adapt the receiving sensitivity of the ultrasonic sensors in the group of ultrasonic sensors which, during asymmetric operation, at least partially have a lower receiving sensitivity than corresponding ultrasonic sensors in the other group of ultrasonic sensors between different receiving sensitivities. The receiving sensitivities can be adjusted, for example, in a stepwise manner or steplessly. In a stepwise adjustment, the receiving sensitivity can be changed over, for example, between a maximum receiving sensitivity, which corresponds to normal operation, and a medium and a low receiving sensitivity, both of which define a form of asymmetric operation. In this case, the receiving sensitivity can be adjusted between the different receiving sensitivities on the basis of, in principle, any of the parameters mentioned, for example on the basis of the travel speed or the environmental conditions. The receiving sensitivity can be adjusted for individual or all ultrasonic sensors in the corresponding group.

In an advantageous configuration of the invention, the method has an additional step for adapting asymmetric operation on the basis of the switch actuation and/or the at least one parameter. It is thus not only possible to change over between asymmetric operation and normal operation, but rather asymmetric operation can also be adapted on the basis of one of the above parameters or the switch actuation. The principles described in detail above regarding the adaptation of asymmetric operation apply. Adapting asymmetric operation may comprise, for example, selecting between operation with a reduced sensitivity on the right-hand side and operation with a reduced sensitivity on the left-hand side. Alternatively or additionally, adapting asymmetric operation may comprise adjusting the ultrasonic sensors which, during asymmetric operation, at least partially have a lower receiving sensitivity than corresponding ultrasonic sensors in the other group of ultrasonic sensors between different receiving sensitivities. Further alternatively or additionally, adapting asymmetric operation may comprise adjusting a subgroup of front or rear ultrasonic sensors if the group of ultrasonic sensors which, during asymmetric operation, at least partially have a lower receiving sensitivity than corresponding ultrasonic sensors in the other group of ultrasonic sensors has at least one subgroup of front ultrasonic sensors and one subgroup of rear ultrasonic sensors. Still further alternatively or additionally, adapting asymmetric operation may comprise adjusting the receiving sensitivity of the ultrasonic sensors in the group of ultrasonic sensors which, during asymmetric operation, at least partially have a lower receiving sensitivity than corresponding ultrasonic sensors in the other group of ultrasonic sensors to a different extent at least partially depending on their position on the vehicle.

The features described above with reference to the sensor arrangement apply correspondingly to the above method and vice versa.

The invention is explained in more detail below with reference to the attached drawing based on preferred embodiments. The features shown may each represent an aspect of the invention both individually and in combination. Features of different exemplary embodiments can be transferred from one exemplary embodiment to another.

### IN THE FIGURES

FIG. 1 shows a schematic view of a vehicle with a sensor arrangement having a plurality of ultrasonic sensors according to a first preferred embodiment,

FIG. 2 shows a schematic view of the vehicle from FIG. 1 with detection areas of selected ultrasonic sensors of the sensor arrangement and areas of a blind spot of the vehicle,

FIG. 3 shows a schematic view of the vehicle from FIG. 1 on a road shown in cross section;

FIG. 4 shows a schematic view of the vehicle from FIG. 1 with spray thrown up behind the vehicle in the detection area of one of the ultrasonic sensors,

FIGS. 5a and 5b shows a schematic illustration of the vehicle from FIG. 1 when passing a road sign with an illustration of the vehicle directly next to the road sign and an illustration of the vehicle after passing the road sign,

FIG. 6 shows a schematic view of a vehicle with a sensor arrangement having a plurality of ultrasonic sensors and a control device according to a second embodiment, and

FIG. 7 shows a flowchart of a method for operating the sensor arrangement of the vehicle in FIG. 6.

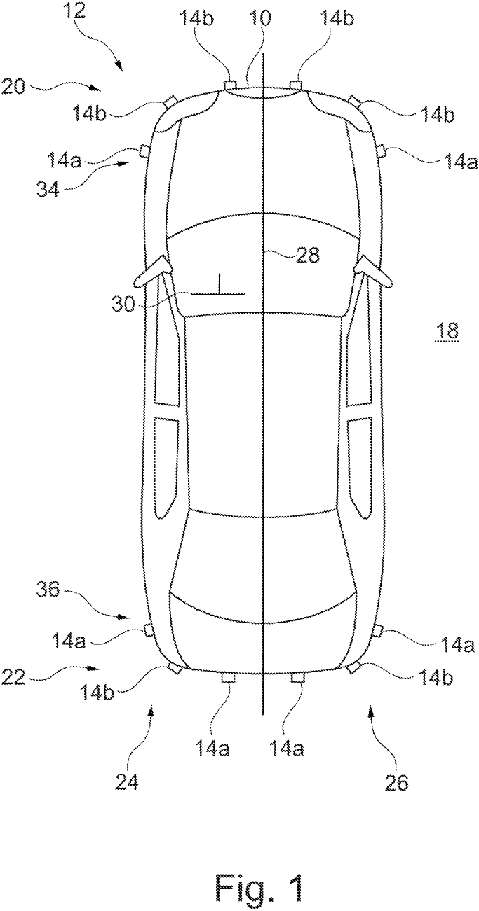

FIG. 1 shows a vehicle 10 with a sensor arrangement 12 according to a first preferred embodiment.

In this exemplary embodiment, the sensor arrangement 12 is designed to be used for a driving assistance system of the vehicle 10. In this exemplary embodiment, the driving assistance system is a driving assistance system for blind spot monitoring, as will be explained further below.

The sensor arrangement 12 comprises a plurality of ultrasonic sensors 14 which are attached to the vehicle 10 for the purpose of capturing an environment 18 of the vehicle 10. The ultrasonic sensors 14 are arranged along a front 20 and a rear 22 of the vehicle 10. In addition, ultrasonic sensors 14 are arranged in side areas of the vehicle 10.

The ultrasonic sensors 14 are divided into a group 24 of right-hand ultrasonic sensors 14 and a group 26 of left-hand ultrasonic sensors 14, as emerges from FIG. 1. The ultrasonic sensors 14 are divided into the two groups 24, 26 along a central axis 28 of the vehicle 10 based on its longitudinal direction. Here, the group 24 of left-hand ultrasonic sensors 14 is formed by all the ultrasonic sensors 14 positioned to the left of the central axis 28 of the vehicle 10, and the group 26 of right-hand ultrasonic sensors 14 is formed by all the ultrasonic sensors 14 positioned to the right of the central axis 28 of the vehicle 10.

The ultrasonic sensors 14 in both groups 24, 26 are attached at the same positions based on the longitudinal axis 28 of the vehicle 10, as a result of which pairs of corresponding ultrasonic sensors 14 are formed in each case. Corresponding ultrasonic sensors 14 are additionally distinguished based on their distance from the central axis 28 of the vehicle 10.

In this exemplary embodiment, the vehicle 10 is in the form of a left-hand-drive vehicle, as indicated by the steering wheel 30 in FIG. 1. In this exemplary embodiment, the sensor arrangement 12 is configured for asymmetric operation in which the ultrasonic sensors 14 in the group 26 of right-hand ultrasonic sensors 14 partially have a lower receiving sensitivity than corresponding ultrasonic sensors 14 in the group 24 of left-hand ultrasonic sensors 14. The sensor arrangement 12 is therefore designed for asymmetric operation with a reduced sensitivity on the right-hand side. The vehicle 10 with the sensor arrangement 12 is thus optimized for a traffic mode with right-hand traffic.

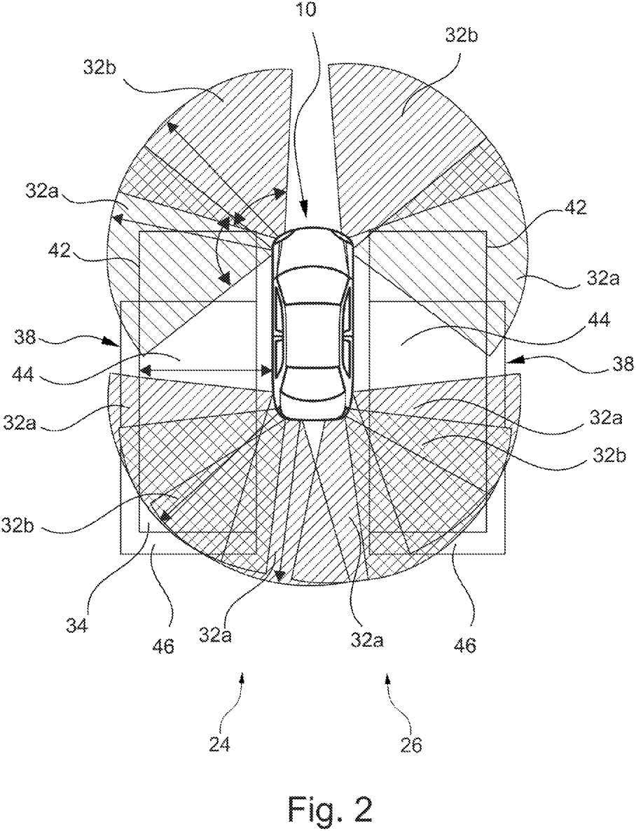

In this exemplary embodiment, asymmetric operation relates to those ultrasonic sensors 14a which are used by the driving assistance system for blind spot monitoring. In this exemplary embodiment, these are a front, laterally oriented ultrasonic sensor 14a, a rear, laterally oriented ultrasonic sensor 14a and a rear, rearwardly oriented ultrasonic sensor 14a from each of the two groups 24, 26 of ultrasonic sensors 14, as shown in FIG. 1. Correspondingly, the detection areas 32 of some ultrasonic sensors 14 of the sensor arrangement 12 are shown in FIG. 2, wherein the detection areas 32a of the ultrasonic sensors 14a which are used by the driving assistance system are accordingly shown in comparison with the detection areas 32b of the ultrasonic sensors 14b which are not used by the driving assistance system. For reasons of clarity, the detection areas 32 of all ultrasonic sensors 14 are not shown in the illustration in FIG. 2. Ultrasonic sensors 14b not used for blind spot monitoring are marked accordingly.

The ultrasonic sensors 14 in the group 26 of right-hand ultrasonic sensors 14 is additionally divided into a subgroup 34 of front ultrasonic sensors 14 and a subgroup 36 of rear ultrasonic sensors 14. In this case, the subgroup 36 of rear ultrasonic sensors 14 is designed with a lower receiving sensitivity than corresponding ultrasonic sensors 14 in the group 24 of left-hand ultrasonic sensors 14. In this exemplary embodiment, the receiving sensitivity of the subgroup 36 of rear ultrasonic sensors 14 is configured directly on the respective ultrasonic sensor 14. In detail, a signal threshold, i.e. a signal level, of a sensor signal from the respective ultrasonic sensor 14 is increased. The corresponding ultrasonic sensors 14 therefore output a warning based on a received sensor signal from the respective ultrasonic sensor 14 if the signal threshold is exceeded. Alternatively or additionally, the lower receiving sensitivity can be achieved by increasing a period of time over which a sensor signal must detect an object in order to output a warning. In this exemplary embodiment, the ultrasonic sensor 14 in the subgroup 34 of front ultrasonic sensors 14 has the same sensitivity as the corresponding ultrasonic sensor 14 in the group 24 of left-hand ultrasonic sensors 14.

The driving assistance system outputs a corresponding blind spot warning when an object is detected in a blind spot 38 based on the ultrasonic sensors 14a used by the driving assistance system for blind spot monitoring. The blind spot 38 is shown here on each side of the vehicle 10 along with a front blocking zone 42. The two blind spots 38 each comprise a necessary alarm zone 44 and an optional alarm zone 46. Accordingly, a blind spot warning can be triggered when the object in the optional alarm zone 46 approaches the vehicle 10, while a blind spot warning must be triggered when the object in the necessary alarm zone 44 approaches the vehicle 10. A blind spot warning is to be blocked in the blocking zone 42. These zones 42, 44, 46 are based on an ISO standard and are universally known in this form.

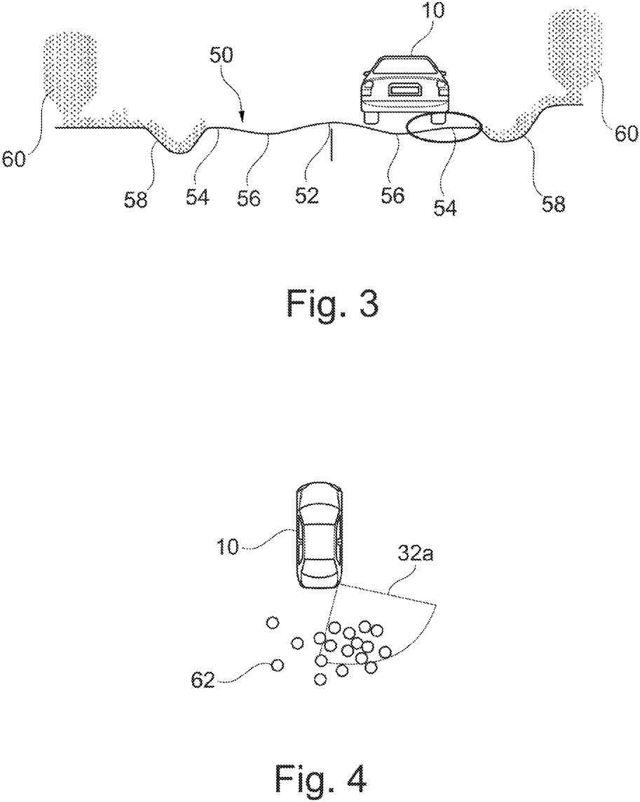

FIGS. 3 and 4 illustrate the improvement in the sensor arrangement 12 for carrying out the blind spot monitoring with the driving assistance system when spray occurs. FIG. 3 shows a profile of a road 50 on which the vehicle 10 is located. The road 50 has a central elevation 52. There is a lower edge elevation 54 in each edge area of the road 50. There is a dip 56 between each of the edge elevations 54 and the central elevation 52. In addition, road ditches 58 and side vegetation 60 are shown in FIG. 3. The profile of the road 50 causes moisture to run off laterally in the direction of the road ditches 58, as a result of which there is typically less moisture on the road 50 in the area of the central elevation 52 than in the area of the edge elevations 54 and in particular the dips 56.

As shown in FIG. 4, this profile of the road 50 causes the vehicle 10 to produce more spray 62 behind the vehicle 10 on the right-hand side than on the left-hand side when driving on the road 50. Incorrect detections of objects by the group 26 of right-hand ultrasonic sensors 14 can be reduced by asymmetric operation. FIG. 4 shows by way of example only the detection area 32a of an ultrasonic sensor 14a used by the driving assistance system.

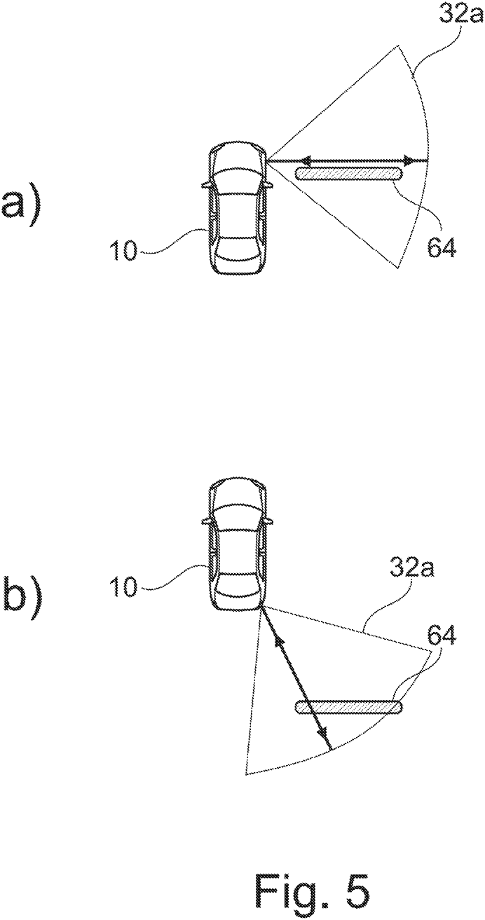

FIG. 5 illustrates the improvement in the sensor arrangement 12 for carrying out the blind spot monitoring with the driving assistance system for road signs 64 located on a right-hand edge of a road. When passing the road sign 64, only slight reflections are produced by a side face of the road sign 64 facing the vehicle 10, with the result that the road sign 64 is not detected, as shown in FIG. 5a). After passing the road sign 64, as shown in FIG. 5b), a front or rear surface of the road sign 64 can cause stronger reflections, as a result of which the road sign 64 is detected. However, road signs 64 are part of fixed installations, and so the detection of road signs 64 is not desired. Incorrect detections of road signs 64 as objects by the group 26 of right-hand ultrasonic sensors 14 can therefore also be reduced by asymmetric operation. This relates to the subgroup 36 of rear ultrasonic sensors 14, since the road signs 64 in the area of the subgroup 34 of front ultrasonic sensors 14 are usually not detected.

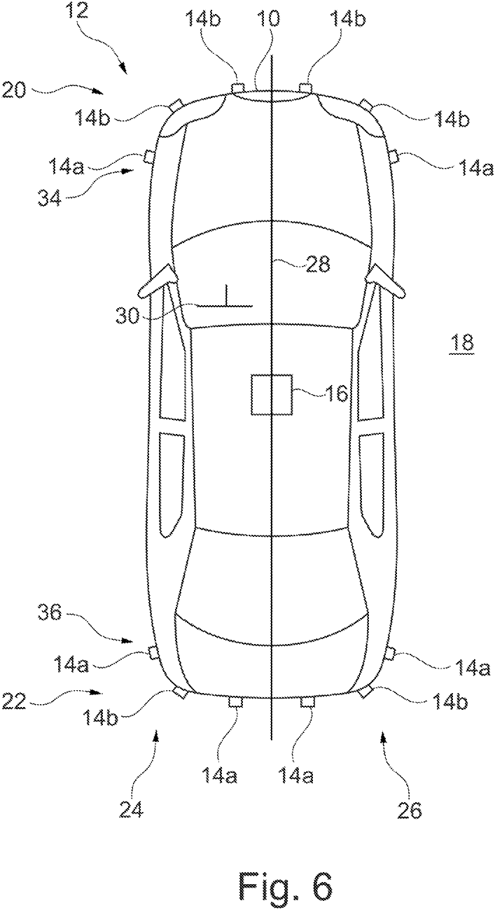

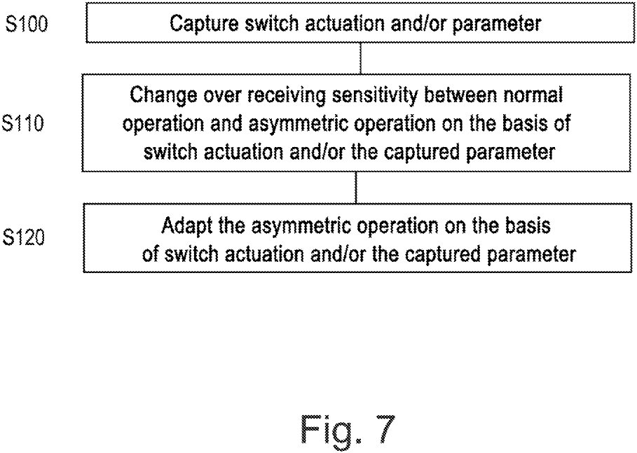

A second exemplary embodiment will be described below with reference to FIGS. 6 and 7. The second exemplary embodiment is based on the vehicle 10 with the sensor arrangement 12 of the first exemplary embodiment, and so only differences between the two exemplary embodiments are described in detail in the description.

The structure of the sensor arrangement 12 of the second exemplary embodiment is shown in FIG. 6 and differs from the sensor arrangement 12 of the first exemplary embodiment in that the sensor arrangement 12 of the second exemplary embodiment additionally has a control device 16. The control device 16 is connected to the ultrasonic sensors 14 via a data connection in a manner not shown in detail here. The data connection is implemented here in the manner of a data bus, in particular as a CAN bus known per se or another data bus used in the automotive sector.

In this exemplary embodiment, the control device 16 is designed to adjust the ultrasonic sensors 14. Alternatively, the control device 16 can also receive sensor signals from the connected ultrasonic sensors 14 and generate warnings based thereon. In this alternative exemplary embodiment, the control device 16 can be an integral part of the driving assistance system for blind spot monitoring.

The control device 16 of the second exemplary embodiment is designed to change over the receiving sensitivity of the groups 24, 26 of left-hand and right-hand ultrasonic sensors 14 between normal operation, in which corresponding ultrasonic sensors 14 in both groups 24, 26 have a substantially identical receiving sensitivity, and asymmetric operation, in which corresponding ultrasonic sensors 14 in a group 24, 26 partially have a lower receiving sensitivity than corresponding ultrasonic sensors 14 in the other group 26, 24 of ultrasonic sensors 14. In this case, the control device 16 can alternatively set a lower receiving sensitivity in the group 24 of left-hand ultrasonic sensors 14 or in the group 26 of right-hand ultrasonic sensors 14. Correspondingly, the control device 16 can set asymmetric operation with a reduced sensitivity on the right-hand side or with a reduced sensitivity on the left-hand side. As described above with reference to the first exemplary embodiment, the two groups 24, 26 of ultrasonic sensors 14 are divided into a subgroup 34, 36 of front and rear ultrasonic sensors 14, wherein the setting by the control device 16 here also affects a change only of the ultrasonic sensors 14 in the subgroup 36 of rear ultrasonic sensors 14. Likewise, asymmetric operation in the second exemplary embodiment relates only to those ultrasonic sensors 14a which are used by the driving assistance system for blind spot monitoring. Reference is made to the above explanations in relation to the sensor arrangement 12 of the first exemplary embodiment. In addition, the control device 16 can adapt asymmetric operation with a reduced sensitivity on the right-hand side as well as with a reduced sensitivity on the left-hand side.

The control device 16 is designed to automatically change over and/or adapt asymmetric operation. Various parameters are taken into account for the automatic changing over and/or adaptation of asymmetric operation, as will become apparent in detail from the explanations below.

In addition, the control device 16 is designed to capture switch actuation of a switch (not shown) of the vehicle 10. The switch can be implemented by a software configuration in the vehicle 10. The switch actuation relates to an indication of a traffic mode with right-hand traffic or left-hand traffic. The control device 16 is also designed to define and set operation with a partially reduced sensitivity on the right-hand or left-hand side as a default setting in accordance with the traffic mode that has been set. Correspondingly, in the case of right-hand traffic, asymmetric operation is set as operation with a partially reduced sensitivity on the right-hand side, and, in the case of left-hand traffic, asymmetric operation is set as operation with a partially reduced sensitivity on the left-hand side. Alternatively, the traffic mode is determined based on data from a global navigation satellite system (GNSS).

The control device 16 is designed to receive a signal indicating a travel speed of the vehicle 10, for example based on odometry information relating to the vehicle 10 or based on satellite navigation signals. The control device 16 is also designed to change over between normal operation and asymmetric operation, either on the right-hand side or on the left-hand side, also taking into account the travel speed of the vehicle 10. Asymmetric operation is started, for example, from a limit speed of 40 to 50 km/h.

The control device 16 is designed to receive a signal indicating a change in the direction of travel of the vehicle 10, for example a signal relating to turn signal actuation or a steering lock of vehicle 10. The change in the direction of travel can include turning, cornering or a lane change. The change in the direction of travel can be currently being carried out or can be currently imminent. The control device 16 is also designed to change over between normal operation and asymmetric operation, also taking into account the change in the direction of travel of the vehicle 10. The change in the direction of travel relates here to a change in the direction of travel toward that side of the vehicle 10 on which the ultrasonic sensors 14 in the group 24, 26 of ultrasonic sensors 14 which, during asymmetric operation, partially have a lower receiving sensitivity than corresponding ultrasonic sensors in the other group 26, 24 of ultrasonic sensors 14 are located. In the case of asymmetric operation on the right-hand side, a change in the direction of travel of the vehicle 10 to the right is therefore evaluated, and vice versa in the case of asymmetric operation on the left-hand side. When the direction of travel is changed, current asymmetric operation is therefore temporarily deactivated until the change in the direction of travel has been completed.

The control device 16 is designed to receive a signal indicating actuation of a windshield wiper of the vehicle 10 as an environmental condition of the vehicle 10. As a result, it can be concluded that it is raining, and so an increased occurrence of spray 62 can be expected. The control device 16 is accordingly designed to activate asymmetric operation only when the windshield wiper is actuated. In addition, the receiving sensitivity of the corresponding ultrasonic sensors 14 can be adjusted depending on an intensity of the actuation of the windshield wiper.

The control device 16 is designed to receive a signal indicating a lane being used from a plurality of available directional lanes. The signal may be generated based on capture of the environment 18 of the vehicle 10 with a camera and/or another environmental sensor. Alternatively or additionally, based on data from a global navigation satellite system (GNSS) together with corresponding map information, it is possible to detect whether a plurality of directional lanes are available and/or which of the directional lanes is being used by the vehicle 10.

The control device 16 is also designed to change over between normal operation and asymmetric operation and/or to adapt asymmetric operation and to change over asymmetric operation between operation with a reduced sensitivity on the right-hand side and operation with a reduced sensitivity on the left-hand side, also taking into account a lane being used by the vehicle 10 from a plurality of available directional lanes.

Accordingly, the control device 16 - starting from right-hand traffic - sets asymmetric operation with a reduced sensitivity on the right-hand side when driving in a right-hand lane, while asymmetric operation with a reduced sensitivity on the left-hand side is set when driving in a left-hand lane. Asymmetric operation is deactivated when driving in a middle lane. The previously stated conditions continue to apply in this case.

A method for operating the sensor arrangement 12 of the second exemplary embodiment will be described below.

Step S100 relates to capturing switch actuation and/or at least one parameter described above from the travel speed, the change in the direction of travel, the lane being used by the vehicle 10 from a plurality of available directional lanes, the traffic mode with right-hand traffic or left-hand traffic and the environmental condition.

Step S110 relates to changing over the receiving sensitivity of the subgroup 36 of rear ultrasonic sensors 14 in one of the groups 24, 26 of ultrasonic sensors 14 between normal operation, in which corresponding ultrasonic sensors 14 in both groups 24, 26 have a substantially identical receiving sensitivity, and asymmetric operation, in which the subgroup 36 of rear ultrasonic sensors 14 in one group 24, 26 of ultrasonic sensors 14 at least partially has a lower receiving sensitivity than corresponding ultrasonic sensors 14 in the other group 26, 24 of ultrasonic sensors 14, on the basis of the switch actuation and/or the at least one parameter.

Step S120 additionally relates to adapting asymmetric operation on the basis of the switch actuation and/or the at least one parameter. The principles described in detail above regarding the adaptation of asymmetric operation apply. In this exemplary embodiment, adapting asymmetric operation comprises selecting between operation with a reduced sensitivity on the right-hand side and operation with a reduced sensitivity on the left-hand side, as well as adjusting the subgroup 36 of rear ultrasonic sensors 14 which, during asymmetric operation, at least partially have a lower receiving sensitivity than corresponding ultrasonic sensors 14 in the other group 26, 24 of ultrasonic sensors 14 between different receiving sensitivities.

List of reference signs

| | |
|---|---|
| 10 | Vehicle |
| 12 | Sensor arrangement |
| 14 | Ultrasonic sensor |
| 14 a | Ultrasonic sensor used by driving assistance system |
| 14 b | Ultrasonic sensor not used by driving assistance system |
| 16 | Control device |
| 18 | Environment |
| 20 | Front |
| 22 | Rear |
| 24 | Group of left-hand ultrasonic sensors |
| 26 | Group of right-hand ultrasonic sensors |
| 28 | Central axis |
| 30 | Steering wheel |
| 32 | Detection area |
| 32 a | Detection area |
| 32 b | Detection area |
| 34 | Subgroup of front ultrasonic sensors |
| 36 | Subgroup of rear ultrasonic sensors |
| 38 | Blind spot |
| 42 | Blocking zone |
| 44 | Necessary alarm zone |
| 46 | Optional alarm zone |
| 50 | Road |
| 52 | Central elevation |
| 54 | Edge elevation |
| 56 | Dip |
| 58 | Road ditch |
| 60 | Vegetation |
| 62 | Spray |
| 64 | Road sign |

1. A sensor arrangement for use for a driving assistance system of a vehicle comprising
a plurality of ultrasonic sensors which are arranged along at least a front and/or a rear of the vehicle
wherein the ultrasonic sensors are divided into a group of right-hand ultrasonic sensors and a group of left-hand ultrasonic sensors, and
wherein the sensor arrangement has asymmetric operation in which the ultrasonic sensors in one group of ultrasonic sensors at least partially have a lower receiving sensitivity than corresponding ultrasonic sensors in the other group of ultrasonic sensors.

2. The sensor arrangement as claimed in claim 1, wherein asymmetric operation has operation with a reduced sensitivity on the right-hand side and/or operation with a reduced sensitivity on the left-hand side, wherein, during operation with a reduced sensitivity on the right-hand side, the ultrasonic sensors in the group of right-hand ultrasonic sensors at least partially have a lower receiving sensitivity than corresponding ultrasonic sensors in the group of left-hand ultrasonic sensors, and, during operation with a reduced sensitivity on the left-hand side, the ultrasonic sensors in the group of left-hand ultrasonic sensors at least partially have a lower receiving sensitivity than corresponding ultrasonic sensors in the group of right-hand ultrasonic sensors.

3. The sensor arrangement as claimed in claim 1, wherein the group of ultrasonic sensors which, during asymmetric operation, at least partially have a lower receiving sensitivity than corresponding ultrasonic sensors in the other group of ultrasonic sensors has at least one subgroup of front ultrasonic sensors and one subgroup of rear ultrasonic sensors, wherein, during asymmetric operation, at least the subgroup of rear ultrasonic sensors at least partially has a lower receiving sensitivity than corresponding ultrasonic sensors in the other group of ultrasonic sensors.

4. The sensor arrangement as claimed in claim 1, wherein the ultrasonic sensors in the group of ultrasonic sensors which, during asymmetric operation, at least partially have a lower receiving sensitivity than corresponding ultrasonic sensors in the other group of ultrasonic sensors at least partially have a different degree of lower receiving sensitivity than corresponding ultrasonic sensors in the other group of ultrasonic sensors, depending on their position on the vehicle.

5. The sensor arrangement as claimed in claim 2, wherein the sensor arrangement has a control device which is connected to the plurality of ultrasonic sensors via a data connection, wherein the sensor arrangement is configured to change over the receiving sensitivity of at least one of the groups of ultrasonic sensors between normal operation, in which corresponding ultrasonic sensors in both groups have a substantially identical receiving sensitivity, and asymmetric operation, and/or to adapt asymmetric operation.

6. The sensor arrangement as claimed in claim 5, wherein the control device is configured to change over between normal operation and asymmetric operation and/or to adapt asymmetric operation, also taking into account a travel speed of the vehicle.

7. The sensor arrangement as claimed in claim 5, wherein the control device is configured to change over between normal operation and asymmetric operation and/or to adapt asymmetric operation, also taking into account a change in the direction of travel of the vehicle.

8. The sensor arrangement as claimed in claim 5, wherein the control device is configured to change over between normal operation and asymmetric operation and/or to adapt asymmetric operation, also taking into account a lane being used by the vehicle from a plurality of available directional lanes.

9. The sensor arrangement as claimed in claim 8, wherein the control device is configured to change over asymmetric operation between operation with a reduced sensitivity on the right-hand side and operation with a reduced sensitivity on the left-hand side, depending on a lane being used by the vehicle from a plurality of available directional lanes.

10. The sensor arrangement as claimed in claim 5, wherein the control device is configured to change over asymmetric operation between operation with a reduced sensitivity on the right-hand side and operation with a reduced sensitivity on the left-hand side, depending on a traffic mode with right-hand traffic or left-hand traffic.

11. The sensor arrangement as claimed in claim 5, wherein the control device is configured to change over between normal operation and asymmetric operation and/or to adapt asymmetric operation, also taking into account at least one environmental condition.

12. The sensor arrangement as claimed in claim 5, wherein the control device is configured to adjust the receiving sensitivity of the ultrasonic sensors in the group of ultrasonic sensors which, during asymmetric operation, at least partially have a lower receiving sensitivity than corresponding ultrasonic sensors in the other group of ultrasonic sensors between different receiving sensitivities.

13. A method for operating a sensor arrangement for use for a driving assistance system of a vehicle, having a plurality of ultrasonic sensors which are arranged along at least a front and/or a rear of the vehicle, wherein the ultrasonic sensors are divided into a group of right-hand ultrasonic sensorsand a groupof left-hand ultrasonic sensors, the method comprising:
capturing switch actuation and/or at least one parameter from a travel speed, a change in the direction of travel, a lane being used by the vehiclefrom a plurality of available directional lanes, a traffic mode with right-hand traffic or left-hand traffic and at least one environmental condition, and
changing over a receiving sensitivity of at least one of the groups of ultrasonic sensors between normal operation, in which corresponding ultrasonic sensorsin both groups have a substantially identical receiving sensitivity, and asymmetric operation, in which the ultrasonic sensors in one group of ultrasonic sensorsat least partially have a lower receiving sensitivity than corresponding ultrasonic sensorsin the other group of ultrasonic sensors, on the basis of the switch actuation and/or the at least one parameter.

14. The method as claimed in claim 13, method further comprising: adapting asymmetric operation on the basis of the switch actuation and/or the at least one parameter.
